(19) United States
(12) Patent Application Publication
(10) Pub. No.: US 2005/0125679 A1
(43) Pub. Date: Jun. 9, 2005

(54) Identification verification system

(76) Inventor: Charles R. Bell, Hinesville, GA (US)

Correspondence Address: LITMAN LAW OFFICES, LTD, PO BOX 15035, CRYSTAL CITY STATION, ARLINGTON, VA, 22215, US

(21) Appl. No.: 10/728,748

(22) Filed: Dec. 8, 2003

(51) Int. Cl. H04K 1/00

(52) U.S. Cl. 713/186

(57) ABSTRACT

A portable, heat-sensitive scanner unit capable of electronic communication with a central database storage facility via a computer unit online system (laptop or desktop PC). The scanner unit has an area on its top surface to receive biometric information such as a fingerprint from an individual. The scanned biometric data is to be compared with data previously obtained from the individual, which data has been stored in the central database. A yellow light is activated on the scanner to confirm that the individual's finger has been properly placed on the scanner and that verification is in process. If identification is verified and approved without any restrictions, a green light is activated. If identification is not verified and approved or there are restrictions, a red light will be activated on the scanner unit to alert officials that further processing of the individual must be made.

### BACKGROUND OF THE INVENTION

1. Field of the Invention

The present invention generally relates to identification systems. More specifically, the present invention is drawn to a system for instantly and easily confirming the identification of pre-registered individuals.

2. Description of the Related Art

Recently, identity theft has become a major problem, resulting in monetary losses in the millions. This criminal phenomenon also results in countless hours of time needed to repair credit records and restore financial reputations. For this reason alone, a portable device utilized to instantly provide verification of an individual's identity would certainly be a welcome addition to the art. Such a device would also be invaluable in areas such as health care, workforce identification, child protection, etc., to insure proper identification of patients, health care personnel and business employees.

There are a plethora of devices in the related art utilized for confirming the identification of individuals. For example, U.S. Pat. No. 6,111,977 (Scott et al.) is drawn to a portable fingerprint transmitter that operates to take the image of a fingerprint and transmit the image to a receiver having previously stored fingerprint images so as to cause a comparison between the image taken and the image stored for purposes of unlocking a security area.

U.S. Pat. No. 5,920,642 (Merjanian) relates to a portable system that includes an ergonomic fingerprint reader that is both a fingerprint acquisition and an account identification device.

U.S. Pat. No. 4,455,083 (Elmes) shows a method and non-portable apparatus for fingerprint verification and identity of a person presenting a credit card.

U.S. Patent Application Publication numbered 2001/0031074 A1 (Yamazika et al.) refers to a system for identifying an individual using a portable communication device with a sensor-incorporated display. The display reads biological information of an individual, and based on the read information, identifies the individual.

U.S. Patent Application Publication numbered 2003/0028811 A1 (Walker et al.) shows a method apparatus and system for authenticating fingerprints. The system is concealed in a hand-held module and allows medical professionals to initiate and perform a plurality of actions by using a fingerprint-induced command.

None of the above inventions and patents, taken either singly or in combination, is seen to disclose a portable fingerprint scanner as will be subsequently described and claimed in the instant invention.

### SUMMARY OF THE INVENTION

The present invention comprises a portable, heat sensitive scanner unit capable of electronic communication with a central database storage facility via a computer unit (laptop or desktop PC) with online capability. The scanner unit has an area on its top surface to receive biometric information from an individual. As contemplated, the biometric data will be in the form of a fingerprint or thumb print. A toe print may also be utilized if necessary (infants and hand loss victims). The scanned biometric data is to be compared with data previously obtained from the individual, which data has been stored in the central database. When identification is to be verified, the individual positions his/her finger on the scanning area. An indicator (yellow light) is activated on the scanner to confirm that the individual's finger has been properly placed on the scanner and that verification is in process. If identification is verified and approved without any restrictions, a signal having a positive connotation is returned, which signal activates a green light on the unit. If identification is not verified and approved or there are restrictions, a signal having a negative connotation is generated and a red light will be activated on the scanner unit to alert officials that further processing of the individual must be made.

Accordingly, it is a principal object of the invention to provide an identification verification system predicated on individual biometric data.

It is another object of the invention to provide an identification verification system based on the electronic comparison of an individuals fingerprint with data stored in a central facility.

It is a further object of the invention to employ a portable, heat sensitive scanner in an identification verification system.

Still another object of the invention is to employ a portable, heat sensitive scanner in an identification verification system, which scanner is connected to a central storage facility via a desktop PC or laptop.

It is an object of the invention to provide improved elements and arrangements thereof for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental, perspective view of a portable fingerprint scanner according to the present invention.

FIG. 2 is a schematic diagram of an identification verification system according to the present invention.

Similar reference characters denote corresponding features consistently throughout the attached drawings.

### DETAILED DESCRIPTION OF THE PREFERRED EMBODIMENT

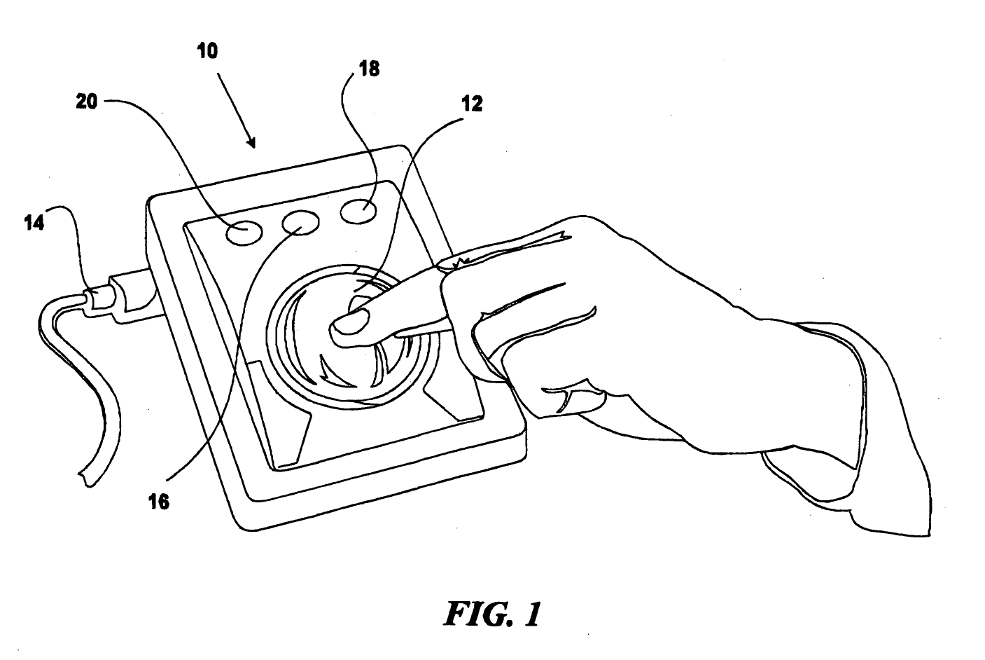

Attention is first directed to FIG. 1, wherein a portable scanner unit is indicated at 10. The top surface of unit 10 is provided with a scanning area 12, which area is heat sensitive and will electronically record biometric data sensed from a fingerprint or thumbprint placed thereon. The scanner 10 is conventional and may take on a form of many of well known scanners available in the related art. Unit 10 incorporates means 14 for connecting the unit to a desktop PC or laptop computer unit. Unit 10 has three indicator lights of different colors 16, 18, and 20.

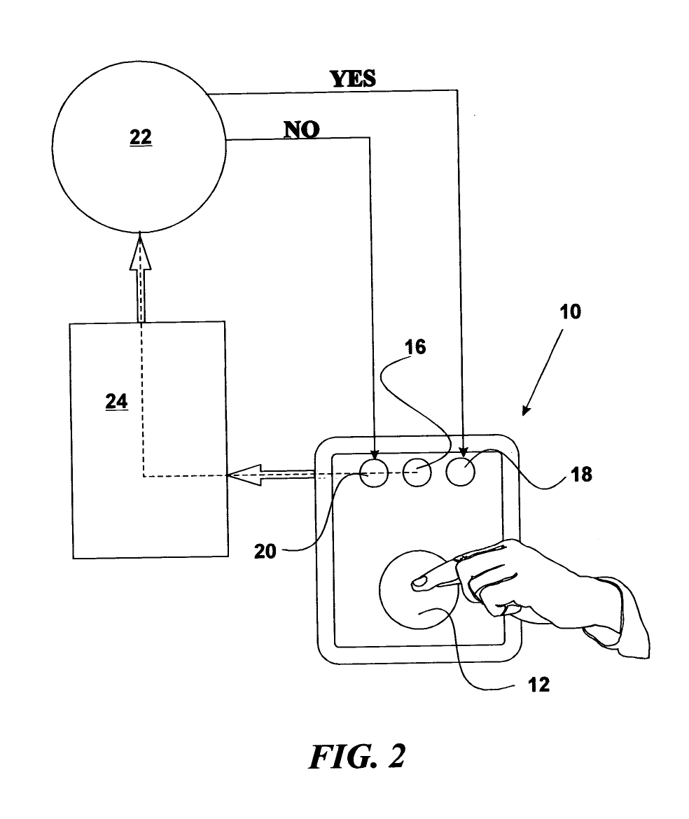

FIG. 2 is a schematic of a system whereby the biometric data obtained from unit 10 is employed to verify the identity of an individual. As seen in the schematic, the individual's biometric data as scanned by unit 10 is transmitted electronically to a remote central database storage facility 22 via a computer 24. An indicator 16 (yellow light) is activated on the scanner to confirm that the individual's finger has been properly placed on the scanner and that verification is in process. If identification is verified and approved without any restrictions, a signal is returned, which signal activates a green light 18 on the unit. If identification is not verified and approved or there are restrictions, a red light 20 will be activated on the scanner unit to alert officials that further processing of the individual must be made.

It is to be understood that the present invention is not limited to the embodiment described above, but encompasses any and all embodiments within the scope of the following claims.

1. An identification verification system comprising:
a portable scanner unit, said scanner unit having a top surface;
a heat-sensitive scanning area disposed on said top surface for recording biometric data;
a computer unit, said scanner unit electronically connected to said computer unit;
a database storage facility remote from said scanner unit and said computer, said database storage facility being electronically connected with said scanner unit by way of said computer to receive said biometric data and to emit a signal in response thereto; and
at least three indicators disposed on said top surface of said scanner unit, said indicators electronically connected to said database storage facility to receive said emitted signal.

2. An identification verification system as recited in claim 1, wherein said biometric data is recorded from a fingerprint.

3. An identification verification system as recited in claim 1, wherein said emitted signal is a signal having a negative connotation and wherein said signal is received by only one indicator of said three indicators.

4. An identification verification system as recited in claim 3, wherein said one indicator is a red light.

5. An identification verification system as recited in claim 1, wherein said emitted signal is a signal having a positive connotation and wherein said signal is received by only one indicator of said three indicators.

6. An identification verification system as recited in claim 5, wherein said one indicator is a green light.

7. An identification verification system as recited in claim 1, wherein said emitted signal is a signal having a processing connotation and wherein said signal is received by only one indicator of said three indicators.

8. An identification verification system as recited in claim 5, wherein said one indicator is a yellow light.

9. An identification verification system comprising:
a portable scanner unit, said scanner unit having a top surface;
a heat-sensitive scanning area disposed on said top surface for recording biometric data derived from a fingerprint;
a computer unit, said scanner unit electronically connected to said computer unit;
a database storage facility remote from said scanner unit and said computer, said database storage facility being electronically connected with said scanner unit by way of said computer to receive said biometric data and to emit a signal in response thereto; and
at least three light-emitting indicators disposed on said top surface of said scanner unit, said light-emitting indicators electronically connected to said database storage facility to receive said emitted signal.

10. An identification verification system as recited in claim 9, wherein said emitted signal is a signal having a negative connotation and wherein said signal is received by only one indicator of said three light-emitting indicators.

11. An identification verification system as recited in claim 10, wherein said one light-emitting indicator is a red light.

12. An identification verification system as recited in claim 9, wherein said emitted signal is a signal having a positive connotation and wherein said signal is received by only one indicator of said three light-emitting indicators.

13. An identification verification system as recited in claim 12, wherein said one light-emitting indicator is a green light.

14. An identification verification system as recited in claim 9, wherein said emitted signal is a signal having a processing connotation and wherein said signal is received by only one indicator of said three indicators.

15. An identification verification system as recited in claim 14, wherein said one indicator is a yellow light.
